(19) United States
(12) Patent Application Publication
(10) Pub. No.: US 2008/0231926 A1
(43) Pub. Date: Sep. 25, 2008

(54) Systems and Methods for Updating Dynamic Three-Dimensional Displays with User Input

(76) Inventors: Michael A. Klug, Austin, TX (US); Mark E. Holzbach, Austin, TX (US)

Correspondence Address: CAMPBELL STEPHENSON LLP, 11401 CENTURY OAKS TERRACE, BLDG. H, SUITE 250, AUSTIN, TX, 78758, US

(21) Appl. No.: 12/050,435

(22) Filed: Mar. 18, 2008

Related U.S. Application Data
(60) Provisional application No. 60/919,092, filed on Mar. 19, 2007.

(51) Int. Cl. G03H 1/26; G02B 27/22

(52) U.S. Cl. 359/23; 359/462

(57) ABSTRACT

A dynamic three-dimensional image can be modified in response to poses or gestures, such as hand gestures, from a user. In one implementation, the gestures are made by a user who selects objects in the three-dimensional image. The gestures can include indications such as pointing at a displayed object, for example, or placing a hand into the volume of space occupied by the three-dimensional image to grab one or more of the displayed objects. In response to the gestures, the three-dimensional display is partially or completely redrawn, for example by an alteration or repositioning of the selected objects. In one implementation, a system simulates the dragging of a displayed three-dimensional object by a user who grabs and moves that object.

This application claims the benefit, under 35 U.S.C. §119(e), of U.S. Provisional Patent Application No. 60/919,092, entitled “Systems and Methods for the Use of Gestural Interfaces with Autostereoscopic Displays,” filed Mar. 19, 2007, and naming Michael Klug and Mark Holzbach as inventors. The above-referenced application is hereby incorporated by reference herein in its entirety.

### BACKGROUND

1. Field of the Invention

The present invention relates in general to the field of holographic images, and more particularly, to user interactions with autostereoscopic holographic displays through poses and gestures.

2. Description of the Related Art

A three-dimensional (3D) graphical display can be termed autostereoscopic when the work of stereo separation is done by the display so that the observer need not wear special eyewear. Holograms are one type of autostereoscopic three-dimensional display and allow multiple simultaneous observers to move and collaborate while viewing a three-dimensional image. Examples of techniques for hologram production can be found in U.S. Pat. No. 6,330,088, entitled “Method and Apparatus for Recording One-Step, Full-Color, Full-Parallax, Holographic Stereograms” and naming Michael Klug, Mark Holzbach, and Alejandro Ferdman as inventors (the “'088 patent”), which is hereby incorporated by reference herein in its entirety.

There is growing interest in autostereoscopic displays integrated with technology to facilitate accurate interaction between a user and three-dimensional imagery. An example of such integration with haptic interfaces can be found in U.S. Pat. No. 7,190,496, entitled “Enhanced Environment Visualization Using Holographic Stereograms” and naming Michael Klug, Mark Holzbach, and Craig Newswanger as inventors (the “'496 patent”), which is hereby incorporated by reference herein in its entirety. Tools that enable such integration can enhance the presentation of information through three-dimensional imagery.

### SUMMARY

Described herein are systems and methods for changing a three-dimensional image in response to input gestures. In one implementation, the input gestures are made by a user who uses an input device, such as a glove or the user's hand, to select objects in the three-dimensional image. The gestures can include indications such as pointing at the displayed objects or placing the input device into the same volume of space occupied by the three-dimensional image. In response to the input gestures, the three-dimensional image is partially or completely redrawn to show, for example, a repositioning or alteration of the selected objects.

In one implementation, the three-dimensional image is generated using one or more display devices coupled to one or more appropriate computing devices. These computing devices control delivery of autostereoscopic image data to the display devices. A lens array coupled to the display devices, e.g., directly or through some light delivery device, provides appropriate conditioning of the autostereoscopic image data so that users can view dynamic autostereoscopic images.

### BRIEF DESCRIPTION OF THE DRAWINGS

The subject matter of the present application may be better understood, and the numerous objects, features, and advantages made apparent to those skilled in the art by referencing the accompanying drawings.

FIG. 1 shows an example of one implementation of an environment in which a user can view and select objects on a display system.

FIG. 2 shows an example of an input device glove being used to interact with a three-dimensional object displayed by a display system.

FIG. 3 shows an example of an operation in which a user moves a three-dimensional object displayed by a display system.

FIG. 4 shows an example of an operation in which a user grabs a displayed three-dimensional object displayed by a display system.

FIG. 5 shows an example of an operation in which a user repositions a three-dimensional object displayed by a display system.

FIG. 6 is a flowchart showing a procedure for displaying and modifying three-dimensional images based on user input gestures.

FIG. 7 is a block diagram of a dynamic display system for three-dimensional images.

FIG. 8 illustrates an example of a dynamic autostereoscopic display module.

FIG. 9 illustrates an example of a multiple element lenslet system that can be used in dynamic autostereoscopic display modules.

### DETAILED DESCRIPTION

The present application discloses various devices and techniques for use in conjunction with dynamic autostereoscopic displays. A graphical display can be termed autostereoscopic when the work of stereo separation is done by the display so that the observer need not wear special eyewear. A number of displays have been developed to present a different image to each eye, so long as the observer remains fixed at a location in space. Most of these are variations on the parallax barrier method, in which a fine vertical grating or lenticular lens array is placed in front of a display screen. If the observer's eyes remain at a fixed location in space, one eye can see only a certain set of pixels through the grating or lens array, while the other eye sees only another set. In other examples of autostereoscopic displays, holographic and pseudo-holographic displays output a partial light-field, computing many different views (or displaying many different pre-computed views) simultaneously. This allows many observers to see the same object simultaneously and to allow for the movement of observers with respect to the display. In still other examples of autostereoscopic displays, direct volumetric displays have the effect of a volumetric collection of glowing points of light, visible from any point of view as a glowing, sometimes semi-transparent, image.

One-step hologram (including holographic stereogram) production technology has been used to satisfactorily record holograms in holographic recording materials without the traditional step of creating preliminary holograms. Both computer image holograms and non-computer image holograms can be produced by such one-step technology. Examples of techniques for one-step hologram production can be found in the '088 patent, referenced above.

Devices and techniques have been developed allowing for dynamically generated autostereoscopic displays. In some implementations, full-parallax three-dimensional emissive electronic displays (and alternately horizontal parallax only displays) are formed by combining high resolution two-dimensional emissive image sources with appropriate optics. One or more computer processing units may be used to provide computer graphics image data to the high resolution two-dimensional image sources. In general, numerous different types of emissive displays can be used. Emissive displays generally refer to a broad category of display technologies which generate their own light, including: electroluminescent displays, field emission displays, plasma displays, vacuum fluorescent displays, carbon-nanotube displays, and polymeric displays. It is also contemplated that non-emissive displays can be used in various implementations. Non-emissive displays (e.g., transmissive or reflective displays) generally require a separate, external source of light (such as, for example, the backlight of a liquid crystal display for a transmissive display, or other light source for a reflective display).

Control of such display devices can be through conventional means, e.g., computer workstations with software and suitable user interfaces, specialized control panels, and the like. In some examples, haptic devices are used to control the display devices, and in some cases manipulate the image volumes displayed by such devices.

The tools and techniques described herein, in some implementations, allow the use of gestural interfaces and natural human movements (e.g., hand/arm movements, walking, etc.) to control dynamic autostereoscopic displays and to interact with images shown in such dynamic autostereoscopic displays. In many implementations, such systems use coincident (or at least partially coincident) display and gesture volumes to allow user control and object manipulation in a natural and intuitive manner.

In various implementations, an autostereoscopic display can use hogels to display a three-dimensional image. Static hogels can be made in some situations using fringe patters recorded in a holographic recording material. The techniques described herein use a dynamic display, which can be updated or modified over time.

One approach to creating a dynamic three-dimensional display also uses hogels. The active hogels of the present application display suitably processed images (or portions of images) such that when they are combined they present a composite autostereoscopic image to a viewer. Consequently, various techniques disclosed in the '088 patent for generating hogel data are applicable to the present application, along with techniques described further below. Hogel data and computer graphics rendering techniques can also be used with the systems and methods of the present application, including image-based rendering techniques.

There are a number of levels of data interaction and display that can be addressed in conjunction with dynamic autostereoscopic displays. For example, in a display enabling the synthesis of fully-shaded 3D surfaces, a user can additively or subtractively modify surfaces and volumes using either a gestural interface, or a more conventional interface (e.g., a computer system with a mouse, glove, or other input device). Fully-shaded representations of 3D objects can be moved around. In more modest implementations, simple binary-shaded iconic data can be overlaid on top of complex shaded objects and data; the overlay is then manipulated in much the same way as cursor or icon is manipulated, for example, on a two-dimensional display screen over a set of windows.

The level of available computational processing power is a relevant design consideration for such an interactive system. In some implementations, the underlying complex visualization (e.g., terrain, a building environment, etc.) can take multiple seconds to be generated. Nonetheless, in a planning situation the ability to make 3D pixels that may be placed anywhere in x, y, z space, or the ability to trace even simple lines or curves in 3D over the underlying visualization is valuable to users of the display. In still other implementations, being able to move interactively a simple illuminated point of light in 3-space provides the most basic interface and interactivity with the 3D display. Building on this technique, various implementations are envisioned where more complex 3D objects are moved or modified in real time in response to a user input. In situations where the calculations for such real time updates are beyond the available processing power, the system may respond to the user input with a time lag, but perhaps with a displayed acknowledgement of the user's intentions and an indication that the system is “catching up” until the revised rendering is complete.

Gestural interfaces are described, for example, in: “‘Put-That-There’: Voice and Gesture at the Graphics Interface,” by Richard A. Bolt, International Conference on Computer Graphics and Interactive Techniques, pp. 262-270, Seattle, Wash., United States, Jul. 14-18, 1980 (“Bolt”); “Multi-Finger Gestural Interaction with 3D Volumetric Displays,” by T. Grossman et al., Proceedings of the 17th Annual ACM Symposium on User Interface Software and Technology, p. 61-70 (“Grossman”); U.S. Provisional Patent Application No. 60/651,290, entitled “Gesture Based Control System,” filed Feb. 8, 2005, and naming John Underkoffler as inventor (the “'290 application); and U.S. patent application Ser. No. 11/350,697, entitled “System and Method for Gesture Based Control System,” filed Feb. 8, 2006, and naming John Underkoffler et al. as inventors (the “'697 application”); all of which are hereby incorporated by reference herein in their entirety.

In some implementations, a gestural interface system is combined with a dynamic autostereoscopic display so that at least part of the display volume and gestural volume overlap. A user navigates through the display and manipulates display elements by issuing one or more gestural commands using his or her fingers, hands, arms, legs, head, feet, and/or their entire body to provide the navigation and control. The gestural vocabulary can include arbitrary gestures used to actuate display commands (e.g., in place of GUI (graphical user interface) or CLI (command line interface) commands) and gestures designed to mimic actual desired movements of display objects (e.g., “grabbing” a certain image volume and “placing” that volume in another location. Gestural commands can include instantaneous commands where an appropriate pose (e.g., of fingers or hands) results in an immediate, one-time action; and spatial commands, in which the operator either refers directly to elements on the screen by way of literal pointing gestures or performs navigational maneuvers by way of relative or offset gestures. Similarly, relative spatial navigation gestures (which include a series of poses) can also be used.

As noted above, the gestural commands can be used to provide a variety of different types of display control. Gestures can be used to move objects, transform objects, select objects, trace paths, draw in two- or three-dimensional space, scroll displayed images in any relevant direction, control zoom, control resolution, control basic computer functionality (e.g., open files, navigate applications, etc.), control display parameters (e.g., brightness, refresh, etc.), and the like. Moreover, users can receive various types of feedback in response to gestures. Most of the examples above focus on visual feedback, e.g., some change in what is displayed. In other examples, there can be audio feedback: e.g., pointing to a location in the display volume causes specified audio to be played back; user interface audio cues (such as those commonly found with computer GUIs); etc. In still other examples, there can be mechanical feedback such as vibration in a floor transducer under the user or in a haptic glove worn by the user. Numerous variations and implementations are envisioned.

In some implementations, the gestural interface system includes a viewing area of one or more cameras or other sensors. The sensors detect location, orientation, and movement of user fingers, hands, etc., and generate output signals to a pre-processor that translates the camera output into a gesture signal that is then processed by a corresponding computer system. The computer system uses the gesture input information to generate appropriate dynamic autostereoscopic display control commands that affect the output of the display.

Numerous variations on this basic configuration are envisioned. For example, gesture interface system can be configured to receive input form more than one user at a time. As noted above, the gestures can be performed by virtually any type of body movement, including more subtle movements such as blinking, lip movement (e.g., lip reading), blowing or exhaling, and the like. One or more sensors of varying types can be employed. In many implementations, one or more motion capture cameras capable of capturing grey-scale images are used. Examples of such cameras include those manufactured by Vicon, such as the Vicon MX40 camera. Whatever sensor is used, motion capture is performed by detecting and locating the hands, limbs, facial features, or other body elements of a user. In some implementations, the body elements may be adorned with markers designed to assist motion-capture detection. Examples of other sensors include other optical detectors, RFID detecting devices, induction detecting devices, and the like.

In one example of motion detection video cameras, the pre-processor is used to generate a three dimensional space point reconstruction and skeletal point labeling associated with the user, based on marker locations on the user (e.g., marker rings on a finger, marker points located at arm joints, etc. A gesture translator is used to convert the 3D spatial information and marker motion information into a command language that can be interpreted by a computer processor to determine both static command information and location in a corresponding display environment, e.g., location in a coincident dynamic autostereoscopic display volume. This information can be used to control the display system and manipulate display objects in the display volume. In some implementations, these elements are separate, while in others they are integrated into the same device. Both Grossman and the '697 application provide numerous examples of gesture vocabulary, tracking techniques, and the types of commands that can be used.

Operation of a gesture interface system in conjunction with a dynamic autostereoscopic display will typically demand tight coupling of the gesture space and the display space. This involves several aspects including: data sharing, space registration, and calibration.

For applications where gestures are used to manipulate display objects, data describing those objects will be available for use by the gesture interface system to accurately coordinate recognized gestures with the display data to be manipulated. In some implementations, the gesture system will use this data directly, while in other implementations an intermediate system or the display system itself uses the data. For example, the gesture interface system can output recognized command information (e.g., to “grab” whatever is in a specified volume and to drag that along a specified path) to the intermediate system or display system, which then uses that information to render and display corresponding changes in the display system. In other cases where the meaning of a gesture is context sensitive, the gesture interface can use data describing the displayed scene to make command interpretations.

For space registration, it is helpful to ensure that the image display volume corresponds to the relevant gesture volume, i.e., the volume being monitored by the sensors. These two volumes can be wholly or partially coincident. In many implementations, the gesture volume will encompass at least the display volume, and can be substantially greater than the display volume. The display volume, in some implementations, is defined by a display device that displays a dynamic three-dimensional image in some limited spatial region. The gesture volume, or interaction volume, is defined in some implementations by a detecting or locating system that can locate and recognize a user's poses or gestures within a limited spatial region. The system should generally be configured so that the interaction volume that is recognized by the detecting or locating system overlaps at least partially with the display device's display volume.

Moreover, the system should be able to geometrically associate a gesture or pose appropriately with the nearby components of the three-dimensional image. Thus, when a user places a finger in “contact” with a displayed three-dimensional object, the system should be able to recognize this geometric coincidence between the detected finger (in the gesture volume) and the displayed three-dimensional object (in the display volume). This coincidence between the gesture volume and the display volume is a helpful design consideration for the arrangement of hardware and for the configuration of supporting software.

Beyond registering the two spaces, it will typically be helpful to calibrate use of the gesture interface with the dynamic autostereoscopic display. Calibration can be as simple as performing several basic calibration gestures at a time or location known by the gesture recognition system. In more complex implementations, gesture calibration will include gestures used to manipulate calibration objects displayed by the dynamic autostereoscopic display. For example, there can be a pre-defined series of gesture/object-manipulation operations designed for the express purpose of calibrating the operation of the overall system.

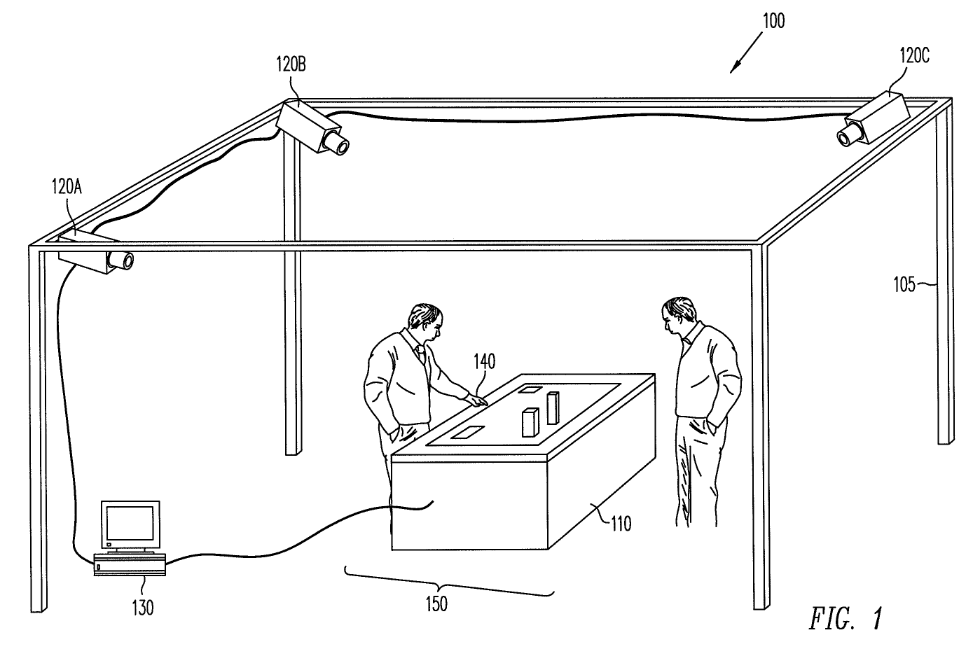

FIG. 1 shows an example of one implementation of an environment 100 in which a user can view and select objects on a display system 110. Display system 110 is capable of displaying three-dimensional images. In one implementation, display system is an autostereoscopic three-dimensional display that uses computer-controlled hogels with directionally controlled light outputs. The environment also includes a set of detectors 120A, 120B, and 120C (collectively, detectors 120) that observe the region around the images from display system 110, and a computer 130 coupled to detectors 120. Each of the detectors 120 includes an infrared emitter that generates a distinctly unique pulsed sequence of infrared illumination, and an infrared camera that receives infrared light. Detectors 120 are securely mounted on a rigid frame 105. Environment 100 also includes at least one user-controlled indicator, which a user can use as an input device to indicate selections of objects displayed by display system 110. In one implementation, the user-controlled indicator is a glove 140. In other implementations, the user-controlled indicator is worn on a head or leg or other body part of a user, or combinations thereof, or is a set of detectors held by a user or mounted on a hand, arm, leg, face, or other body part of the user, or combinations thereof. In yet other implementations, the user-controlled indicator is simply a body part of the user (such as a hand, a finger, a face, a leg, or a whole-body stance, or combinations thereof) detected by cameras or other detection devices. Various combinations of these user-controlled indicators, and others, are also contemplated.

The objects displayed by display system 110 include three-dimensional objects, and in some implementations may also include two-dimensional objects. The displayed objects include dynamic objects, which may be altered or moved over time in response to control circuits or user input to display system 110. In this example, display system 110 is controlled by the same computer 130 that is coupled to detectors 120. It is also contemplated that two or more separate networked computers could be used. Display system 110 displays stereoscopic three-dimensional objects when viewed by a user at appropriate angles and under appropriate lighting conditions. In one implementation, display system 110 displays real images—that is, images that appear to a viewer to be located in a spatial location that is between the user and display system 110. Such real images are useful, for example, to provide users with access to the displayed objects in a region of space where users can interact with the displayed objects. In one application, real images are used to present “aerial” views of geographic terrain potentially including symbols, people, animals, buildings, vehicles, and/or any objects that users can collectively point at and “touch” by intersecting hand-held pointers or fingers with the real images. Display system 110 may be implemented, for example, using various systems and techniques for displaying dynamic three-dimensional images such as described below. The dynamic nature of display system 110 allows users to interact with the displayed objects by grabbing, moving, and manipulating the objects.

Various applications may employ a display of the dynamic three-dimensional objects displayed by display system 110. For example, the three-dimensional objects may include objects such as images of buildings, roads, vehicles, and bridges based on data taken from actual urban environments. These objects may be a combination of static and dynamic images. Three-dimensional vehicles or people may be displayed alongside static three-dimensional images of buildings to depict the placement of personnel in a dynamic urban environment. As another example, buildings or internal walls and furniture may be displayed and modified according to a user's input to assist in the visualization of architectural plans or interior designs. In addition, static or dynamic two-dimensional objects may be used to add cursors, pointers, text annotations, graphical annotations, topographic markings, roadmap features, graphical annotations, and other static or dynamic data to a set of three-dimensional scenes or objects, such as a geographic terrain, cityscape, or architectural rendering.

In the implementation shown in FIG. 1, detectors 120 gather data on the position in three-dimensional space of glove 140, as well as data on any made by the arrangement of the fingers of the glove. As the user moves, rotates, and flexes the glove around interaction region 150, detectors 120 and computer 130 use the collected data on the location and poses of the glove to detect various gestures made by the motion of the glove. For example, the collected data may be used to recognize when a user points at or “grabs” an object displayed by system 110.

In different implementations, other input devices can be used instead of or in addition to the glove, such as pointers or markers affixed to a user's hand. With appropriate image-recognition software, the input device can be replaced by a user's unmarked hand. In other implementations, input data can be collected not just on a user's hand gestures, but also on other gestures such as a user's limb motions, facial expression, stance, posture, and breathing.

It is also contemplated that in some implementations of the system, static three-dimensional images may be used in addition to, or in place of, dynamic three-dimensional images. For example, display system 110 can include mounting brackets to hold hologram films. The hologram films can be used to create three-dimensional images within the display volume. In some implementations, the hologram films may be marked with tags that are recognizable to detectors 120, so that detectors 120 can automatically identify which hologram film has been selected for use from a library of hologram films. Similarly, identifying tags can also be placed on overlays or models that are used in conjunction with display system 110, so that these items can be automatically identified.

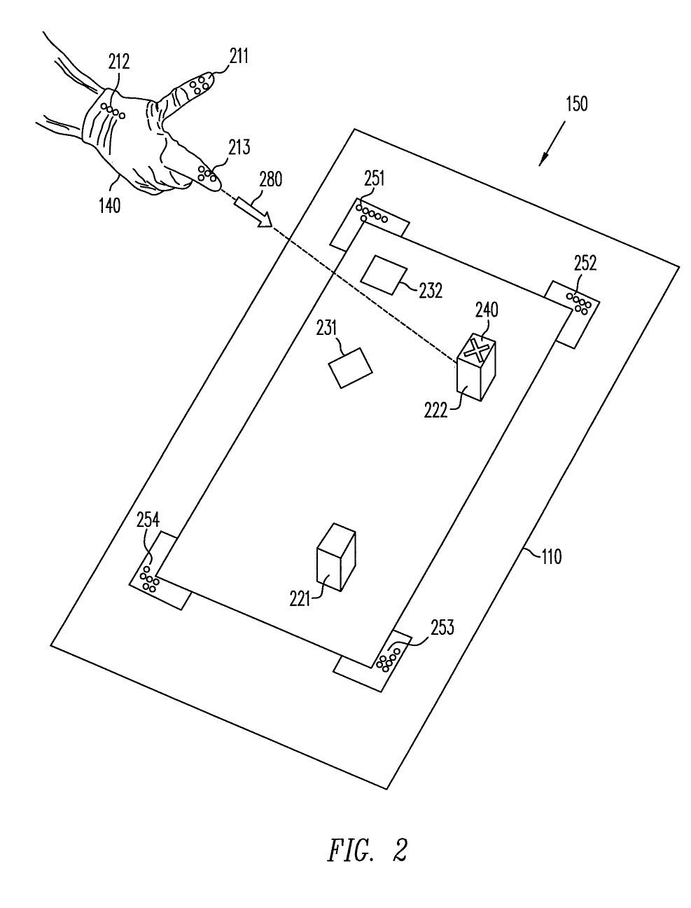

FIG. 2 shows an example of input device glove 140 being used to interact with a three-dimensional object displayed by display system 110 in the example from FIG. 1. A user wearing the glove makes a “gun” pose, with the index finger and thumb extended at an approximately 90° angle and the other fingers curled towards the palm of the hand. In one implementation of environment 100, the gun pose is used to point at locations and objects displayed by display system 110. The user can drop the thumb of the gun pose into a closed position approximately parallel to the index finger. This motion is understood by detectors 120 and computer 130 from FIG. 1 as a gesture that selects an object at which the gun pose is pointing.

Several objects are displayed in FIG. 2. These objects include two two-dimensional rectangular objects 231 and 232. These objects also include two three-dimensional objects 221 and 222 (two rectangular blocks representing, for example, buildings or vehicles), that are visible to a user who views display system 110 from appropriate angles. In some embodiments, the three-dimensional objects include miniature three-dimensional representations of buildings or vehicles or personnel in addition to, or instead of, the simple three-dimensional blocks of FIG. 2.

In this example, the user uses the gun pose to point at object 222. Object 222 is a computer-generated three-dimensional block displayed by display system 110. To assist the user in pointing at a desired object, display system 110 also displays a two-dimensional cursor 240 that moves along with a location at which the gun pose points in the displayed image. The user can then angle the gun pose of glove 140 so that the cursor 240 intersects the desired object, such as three-dimensional object 222. This geometrical relationship—the user pointing at a displayed object as shown in FIG. 2—is detected by computer 130 from FIG. 1 using detectors 120.

Environment 100 carries out a variety of operations so that computer 130 is able to detect such interactions between a user and the displayed objects. For example, detecting that a user is employing glove 140 to point at object 222 involves (a) gathering information on the location and spatial extents of object 222 and other objects being displayed, (b) gathering information on the location and pose of glove 140, (c) performing a calculation to identify a vector 280 along which glove 140 is pointing, and (d) determining that the location of object 222 coincides with those coordinates. The following discussion addresses each of these operations. These operations rely on an accurate spatial registration of the location of glove 140 with respect to the locations of the displayed objects. It is helpful to ensure that the image display volume corresponds to the relevant gesture volume, i.e., the volume for which sensors are configured to monitor. In many implementations, the gesture volume will encompass at least a substantial part of the display volume, and can be substantially greater than the display volume. The intersection of the display volume and the gesture volume is included in the interaction region 150.

Various techniques may be used to gather information on the location and spatial extents of the objects displayed by display system 110. One approach requires a stable location of display system 110, fixed with respect to frame 105. The location of display system 110 can then be measured relative to detectors 120, which are also stably mounted on frame 105. This relative location information can be entered into computer 130. Since the location of display system 110 defines the display region for the two- and three-dimensional images, computer 130 is thus made aware of the location of the display volume for the images. The displayed three-dimensional objects will thus have well-defined locations relative to frame 105 and detectors 120.

Data concerning the objects displayed by display system 110 can be entered into computer 130. These data describe the apparent locations of the dimensional objects with respect to display system 110. These data are combined with data regarding the position of display system 110 with respect to frame 105. As a result, computer 130 can calculate the apparent locations of the objects with respect to display system 110, and thus, with respect to the interaction region 150 in which the two- and three-dimensional images appear to a user, and in which a user's gestures can be detected. This information allows computer 130 to carry out a registration with 1:1 scaling and coincident spatial overlap of the three-dimensional objects with the input device in interaction region 150.

A second approach is also contemplated for gathering information on the location and spatial extents of the displayed two- and three-dimensional objects. This approach is similar to the approach described above, but can be used to relax the requirement of a fixed location for display system 110. In this approach, display system 110 does not need to have a predetermined fixed location relative to frame 105 and detectors 120. Instead, detectors 120 are used to determine the location and orientation of display system 110 during regular operation. In various implementations, detectors 120 are capable of repeatedly ascertaining the location and orientation of display system 110, so that even if display system 110 is shifted, spun, or tilted, the relevant position information can be gathered and updated as needed. Thus, by tracking any movement of display system 110, detectors 120 can track the resulting movement of the displayed objects.

One technique by which detectors 120 and computer 130 can determine the location of display system 110 is to use recognizable visible tags attached to display system 110. The tags can be implemented, for example, using small retroreflecting beads, with the beads arranged in unique patterns for each tag. As another example, the tags may be bar codes or other optically recognizable symbols. In the example of FIG. 2, display system 110 has four distinct visible tags 251, 252, 253, and 254. These tags are shown as combinations of dots arranged in four different geometric patterns, placed at the four corners of display system 110. Measurements regarding the location of these four tags on the display system 110 are pre-entered into computer 130. When detectors 120 detect the locations in three-space of the four tags, these locations can be provided to computer 130. Computer 130 can then deduce the location and orientation of display system 110.

In one implementation, detectors 120 use pulsed infrared imaging and triangulation to ascertain the locations of each of the tags 251, 252, 253, and 254 mounted on display system 110. Each of the detectors 120A, 120B, and 120C illuminates the region around display system 110 periodically with a pulse of infrared light. The reflected light is collected by the emitting detector and imaged on a charge coupled device (or other suitable type of sensor). Circuitry in each detector identifies the four tags based on their unique patterns; the data from the three detectors is then combined to calculate the position in three-space of each of the four tags. Additional detectors may also be used. For example, if four or five detectors are used, the additional detector(s) provides some flexibility in situations where one of the other detectors has an obscured view, and may also provide additional data that can improve the accuracy of the triangulation calculations. In one implementation, environment 100 uses eight detectors to gather data from the interaction region 150.

Detectors 120 may include motion capture detectors that use infrared pulses to detect locations of retroreflecting tags. Such devices are available, for example, from Vicon Limited in Los Angeles, Calif. The infrared pulses may be flashes with repetition rates of approximately 90 Hz, with a coordinated time-base operation to isolate the data acquisition among the various detectors. Tags 251, 252, 253, and 254 may be implemented using passive retroreflecting beads with dimensions of approximately 1 mm. With spherical beads and appropriate imaging equipment, a spatial resolution of approximately 0.5 mm may be obtained for the location of the tags. Further information on the operation of an infrared location system is available in the '290 and '697 applications, referenced above. Detectors 120 can be configured to make fast regular updates of the locations of tags 251, 252, 253, and 254. Thus, computer 130 can be updated if the location of the tags, and therefore of display system 110 moves over time. This configuration can be used to enable a rotating tabletop.

In addition to gathering information on the locations and spatial extents of displayed objects, detectors 120 and computer 130 can also be used to gather information on the location and pose of glove 140. In the example of FIG. 2, additional tags 211, 212, and 213 are attached on the thumb, index finger, and wrist, respectively, of glove 140. Additional tags may also be used on glove 140. By obtaining the three-space location of the tags, detectors 120 obtain position information for the parts of the glove to which they are attached.

With appropriate placement of the tags, and with consideration of the anatomy of a hand, detectors 120 and computer 130 can use the three-space positions of tags 211, 212, and 213 to determine the location, pose, and gesturing of the glove. In the example of FIG. 2, the three-space positions of the glove-mounted tags 211, 212, and 213 indicate where glove 140 is located and also that glove 140 is being held in a gun pose. That is, the positions of the glove-mounted tags, relative to each other, indicate that the index finger is extended and the thumb is being held away from the index finger in this example. The pose of glove 140 can similarly be deduced from the information about the positions of tags 211, 212, and 213. The pose may be characterized, for example, by angles that describe the inclination of the pointing index finger (e.g., the direction of a vector between tags 212 and 213), and the inclination of the extended thumb (using tags 211 and 212 and appropriate anatomical information).

Having deduced that the glove 140 is being held in a gun pose, computer 130 (from FIG. 1) can proceed to identify coordinates at which glove 140 is pointing. That is, computer 130 can use the position information of tags 211, 212, and 213 and appropriate anatomical information to calculate the vector 280 along which the user is pointing. The anatomical information used by computer 130 can include data about the arrangements of the tags that imply a pointing gesture, and data about the implied direction of pointing based on the tag locations.

Computer 130 then performs a calculation to determine which object(s), if any, have coordinates along the vector 280. This calculation uses the information about the positions of the two- and three-dimensional objects, and also employs data regarding the extents of these objects. If the vector 280 intersects the extents of an object, computer 130 ascertains that the user is pointing at that object. In the example of FIG. 2, the computer ascertains that the user is pointing at three-dimensional object 222. Visual feedback can be provided to the user, for example by causing object 222 to visibly undulate or change color (not shown) when the user points at object 222. In addition or instead, auditory feedback, for example using a beep sound generated by a speaker coupled to computer 130, can also be provided to show that the user is pointing at an object.

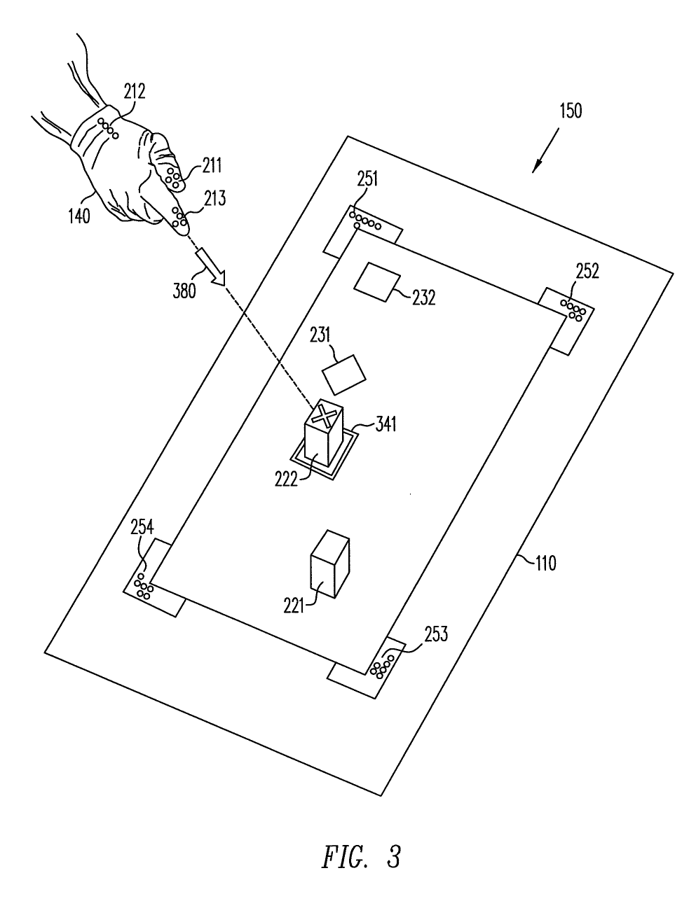

FIG. 3 shows an example of an operation in which a user moves three-dimensional object 222 within the dynamic image generated by display system 110. In comparison with FIG. 2, object 222 has been repositioned. This operation involves the user selecting the object by changing the pose of glove 140, and moving the object by a motion of the glove. In the illustrated example, a user changes the pose of the glove from an open gun to a closed gun by bringing the thumb close to the index finger while pointing at object 231. This motion is interpreted as a gesture that selects object 222. Detectors 120 detect the resulting locations of tags 211, 212, and 213 on the glove, and pass these locations on to computer 130. Computer 130 determines that the locations of the tags have changed relative to each other and recognizes the change as indicating a selection gesture. Since the user is pointing at object 222 while the selection gesture is performed, computer 130 deems this object 222 to be selected by the user. Visual feedback can be provided to the user, for example by displaying a two-dimensional highlight border 341 around object 222 to indicate that the user has selected object 222. In addition or instead, auditory feedback, for example using a beep sound, can also be provided to show that the user has selected an object. (Other indications of visual and auditory feedback for selected objects are also contemplated, such as a change in size, a geometric pulsing, an encircling, a change in color, or a flashing of the selected object, or an auditory chime, bell, or other alert sound, or others, or some combination thereof. Similarly, various forms of visual, audible, or haptic feedback can also be provided when a user points at a displayed object.)

Computer 130 can also change the displayed objects in response to a change in location or pose of glove 140. In the illustrated example, the user has changed the direction at which the glove points; the direction of pointing 380 is different in FIG. 3 than it was (280) in FIG. 2. This motion is used in the illustrated example to move a selected object in the displayed image. As illustrated, object 222 has been repositioned accordingly. The user may de-select object 222 in the new location by raising the thumb (not shown), thereby returning glove 140 to the open gun pose. Computer 130 would respond accordingly by removing the highlight border 341 from object 222 in the new position.

The user-directed repositioning of three-dimensional objects may be usable to illustrate the motion of vehicles or people in an urban or rural setting; or to illustrate alternative arrangements of objects such as buildings in a city plan, exterior elements in an architectural plan, or walls and appliances in an interior design; or to show the motion of elements of an educational or entertainment game. Similarly, some implementations of the system may also enable user-directed repositioning of two-dimensional objects. This feature may be usable, for example, to control the placement of two-dimensional shapes, text, or other overlay features.

Other user-directed operations on the displayed objects are also contemplated. For example, a two-handed gesture may be used to direct relative spatial navigation. While a user points at an object with one hand, for example, the user may indicate a clockwise circling gesture with the other hand. This combination may then be understood as a user input that rotates the object clockwise. Similarly, various one or- two-handed gestures may be used as inputs to transform objects, trace paths, draw, scroll, pan, zoom, control spatial resolution, control slow-motion and fast-motion rates, or indicate basic computer functions.

A variety of inputs are contemplated, such as inputs for arranging various objects in home positions arrayed in a grid or in a circular pattern. Various operations can be done with right-hand gestures, left-hand gestures, or simultaneously with both hands. More than two hands simultaneously are even possible, i.e. with multiple users. For example, various operations may be performed based on collaborative gestures that involve a one-handed gesture from a user along with another one-handed gesture from another user. Similarly, it is contemplated that multi-user gestures may be involve more than two users and/or one or two-handed gestures by the users.

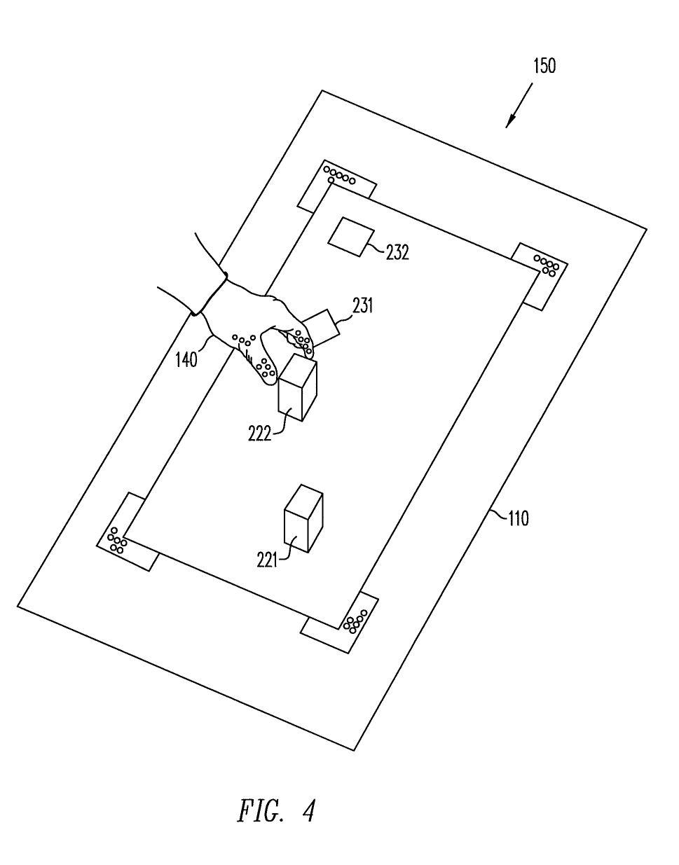

FIG. 4 shows an example of an operation in which a user grabs a displayed three-dimensional object projected by display system 110. In this example, a user employs glove 140 to reach toward object 222 and close the fingers of glove 140 onto object 222. The user concludes the motion with the finger tips located at the apparent positions of the sides of object 222. This motion is detected by detectors 120 from FIG. 1 and is communicated to computer 130. Computer 130 uses the information on this motion in conjunction with information on the location and extents of object 222 to interpret the motion as a grabbing gesture. Various forms of visual or auditory feedback may be provided to inform the user that the grabbing of object 222 has been recognized by the system.

In various implementations of the system, a user would not have tactile feedback to indicate that the fingertips are “touching” the sides of the displayed three-dimensional object 222. Computer 120 may be appropriately programmed to accept some inaccuracy in the placement of the users fingers for a grabbing gesture. The degree of this tolerance can be weighed against the need to accurately interpret the location of the user's fingers with respect to the dimensions of the neighboring objects. In other implementations, the system may provide tactile feedback to the user through auditory, visual, or haptic cues to indicate when one or more fingers are touching the surface of a displayed object.

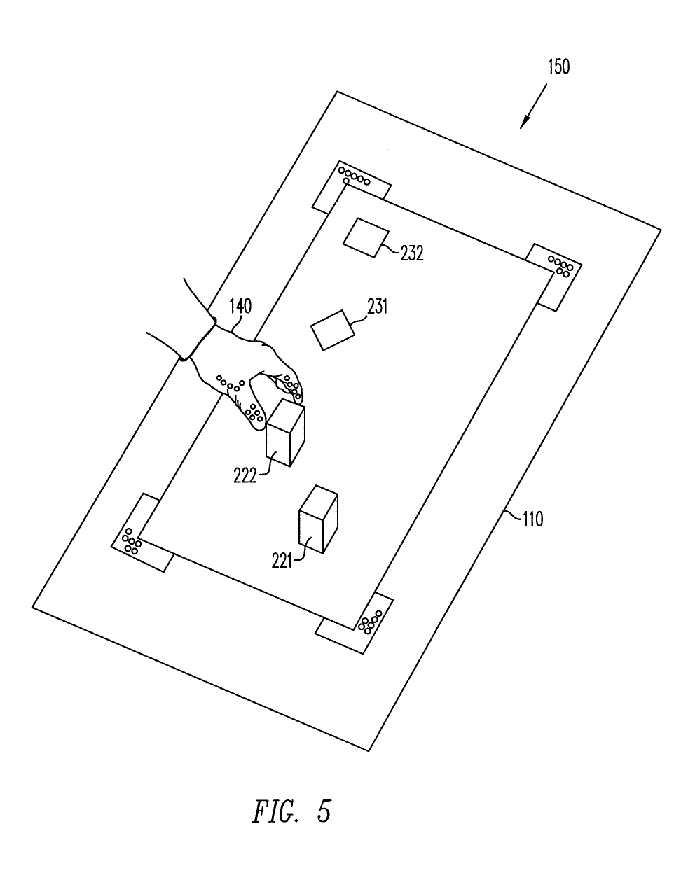

FIG. 5 shows an example of an operation in which a user moves a three-dimensional object 222 projected by a display system. In this example, a user has grabbed object 222, as was shown in FIG. 4. The user has repositioned object 222 by moving glove 140 to a different location within the interaction region while maintaining the grabbing gesture. Display system 110 has responded by re-displaying the object in the new position. With rapid enough updates, the display system can simulate a dragging of the grabbed object within the interaction region. The user may de-select and “release” object 222 in the new position by undoing the grabbing gesture and removing the hand from the vicinity of object 222. Computer 130 could respond accordingly by leaving object 222 in the new position. In various implementations, computer 130 could provide an audible feedback cue for the releasing, or could undo any visual cues that were shown for the grabbing gesture.

The above examples describe the repositioning of a displayed three-dimensional object 222 (in FIGS. 2-5) in response to gesture of a user. More complicated operations are also envisioned. In one implementation, these techniques can be used for the discussion among various users for the aesthetic placement of architectural elements in a three-dimensional model of a building that is dynamically displayed by display system 110. One user can propose the repositioning of a door or wall in the model; by modifying the displayed model with appropriate gestures, the user can readily show the three-dimensional result to other users who are also looking at the displayed model. Similarly, strategic placement of personnel and equipment can be depicted in a three-dimensional “sand table” miniature model that shows the layout of personnel, equipment, and other objects in a dynamic three-dimensional display. Such a sand table may be useful for discussions among movie-set designers, military planners, or other users who may benefit from planning tools that depict situations and arrangements, and which can respond to user interactions. When one user grabs and moves a miniature displayed piece of equipment within a sand table model, the other users can see the results and can appreciate and discuss the resulting strategic placement of the equipment within the model.

In one implementation, a sand table model using a dynamic three-dimensional display can be used to display real-time situations and to issue commands to outside personnel. For example, a sand table model can display a miniature three-dimensional representation of various trucks and other vehicles in a cityscape. In this example, the displayed miniature vehicles represent the actual locations in real time of physical trucks and other vehicles that need to be directed through a city that is represented by the cityscape. This example uses real-time field information concerning the deployment of the vehicles in the city. This information is conveniently presented to users through the displayed miniature cityscape of the sand table.

When a user of the sand table in this example grabs and moves one of the displayed miniature trucks, a communication signal can be generated and transmitted to the driver of the corresponding physical truck, instructing the driver to move the truck accordingly. Thus, the interaction between the sand table model and the real world may be bidirectional: the sand table displays the existing real-world conditions to the users of the sand table. The users of the sand table can issue commands to modify those existing conditions by using poses, gestures, and other inputs that are (1) detected by the sand table, (2) used to modify the conditions displayed by the sand table, and (3) used to issue commands that will modify the conditions in the real world.

In one implementation, the sand table may use various representations to depict the real-world response to a command. For example, when a user of the sand table grabs and moves a displayed miniature model of a truck, the sand table may understand this gesture as a command for a real-world truck to be moved. The truck may be displayed in duplicate: an outline model that acknowledges the command and shows the desired placement of the truck, and a fully-shaded model that shows the real-time position of the actual truck as it gradually moves into the desired position.

It is also contemplated that the poses and gestures may be used in conjunction with other commands and queries, such as other gestures, speech, typed text, joystick inputs, and other inputs. For example, a user may point at a displayed miniature building and ask aloud, “what is this?” In one implementation, a system may register that the user is pointing at a model of a particular building, and may respond either in displayed text (two- or three-dimensional) or in audible words with the name of the building. As another example, a user may point with one hand at a displayed miniature satellite dish and say “Rotate this clockwise by twenty degrees” or may indicate the desired rotation with the other hand. This input may be understood as a command to rotate the displayed miniature satellite dish accordingly. Similarly, in some implementations, this input may be used to generate an electronic signal that rotates a corresponding actual satellite dish accordingly.

Networked sand tables are also contemplated. For example, in one implementation, users gathered around a first sand table can reposition or modify the displayed three-dimensional objects using verbal, typed, pose, or gestural inputs, among others. In this example, the resulting changes are displayed not only to these users, but also to other users gathered around a second adjunct sand table at a remote location. The users at the adjunct sand table can similarly make modifications that will be reflected in the three-dimensional display of the first sand table.

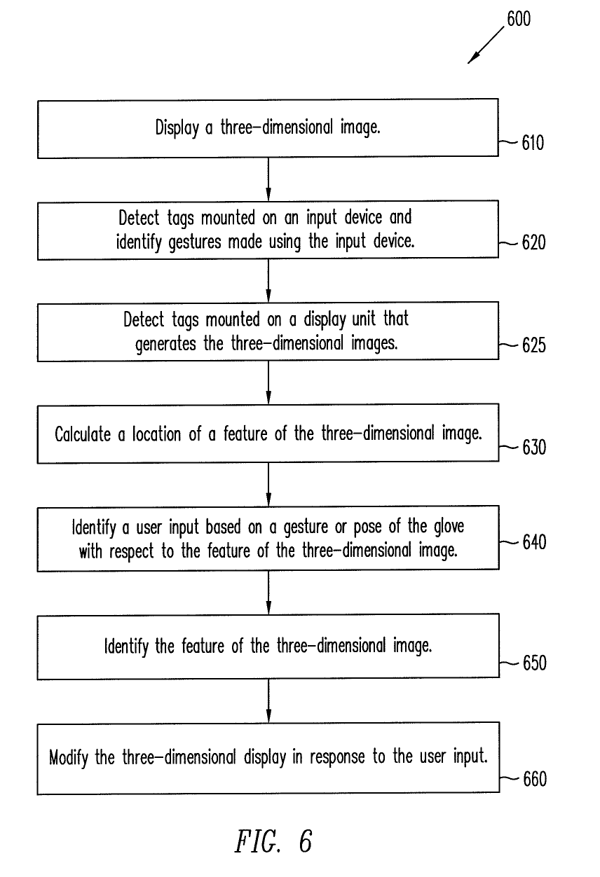

FIG. 6 is a flowchart showing a procedure 600 for recognizing user input in an environment that displays dynamic three-dimensional images. The procedure commences in act 610 by displaying a three-dimensional image. The image may also include two-dimensional elements, and may employ autostereoscopic techniques, may provide full-parallax viewing, and may display a real image. For example, the image may be produced by an array of computer-controlled hogels that are arranged substantially contiguously on a flat surface. Each hogel may direct light in various directions. The emission of light into the various directions by a hogel is controlled in concert with the other hogels to simulate the radiated light pattern that would result from an object. The resulting light pattern displays that object to a viewer looking at the array of hogels. The display may be augmented with two-dimensional display systems, such as a projector, to add two-dimensional elements onto a physical surface (e.g., the surface of the hogel array or an intervening glass pane).

The procedure continues in act 620 by detecting tags mounted on a glove worn by a user, and by determining the location and pose of the glove based on the tags. In act 625, the procedure detects tags mounted with a fixed relationship to the three-dimensional image (e.g., mounted on a display unit that generates the three-dimensional images). Based on these tags, a determination is made of the location and orientation of the three-dimensional image.

In act 630, the procedure calculates a location of a feature of the three-dimensional image. This calculation is based on the locations of the tags mounted with respect to the three-dimensional image, and on data describing the features shown in the three-dimensional image. The procedure then calculates a distance and direction between the glove and the feature of the three-dimensional image.

In act 640, the procedure identifies a user input based on a gesture or pose of the glove with respect to a displayed three-dimensional object in the image. The gesture or pose may be a pointing, a grabbing, a touching, a wipe, an “ok” sign, or some other static or moving pose or gesture. The gesture may involve a positioning of the glove on, within, adjacent to, or otherwise closely located to the displayed three-dimensional object. In act 650, the procedure identifies the three dimensional object that is the subject of the gesture or pose from act 640. In act 660, the procedure modifies the three-dimensional display in response to the user input. The modification may be a redrawing of all or some of the image, a repositioning of the object in the image, a dragging of the object, a resizing of the object, a change of color of the object, or other adjustment of the object, of neighboring object(s), or of the entire image.

Various examples of active autostereoscopic displays are contemplated. Further information regarding autostereoscopic displays may be found, for example, in U.S. Pat. No. 6,859,293, entitled “Active Digital Hologram Display” and naming Michael Klug, et al. as inventors (the “'293 patent”); U.S. patent application Ser. No. 11/724,832, entitled “Dynamic Autostereoscopic Displays,” filed on Mar. 15, 2007, and naming Mark Lucente et al. as inventors (the “'832 application”); and U.S. patent application Ser. No. 11/834,005, entitled “Dynamic Autostereoscopic Displays,” filed on Aug. 5, 2007, and naming Mark Lucente et al., as inventors (the “'005 application”), which are hereby incorporated by reference herein in their entirety.

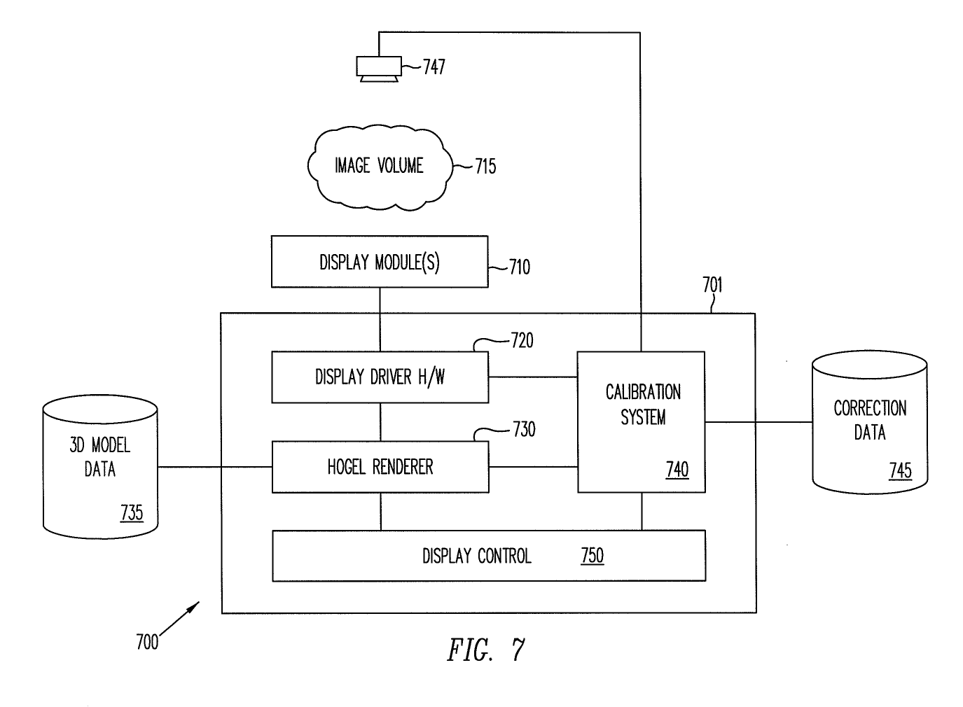

FIG. 7 illustrates a block diagram of an example of a dynamic autostereoscopic display system 700. Various system components are described in greater detail below, and numerous variations on this system design (including additional elements, excluding certain illustrated elements, etc.) are contemplated. System 700 includes one or more dynamic autostereoscopic display modules 710 that produce dynamic autostereoscopic images illustrated by display volume 715. In this sense, an image can be a two-dimensional or three-dimensional image. These modules use light modulators or displays to present hogel images to users of the device. In general, numerous different types of emissive or non-emissive displays can be used. Emissive displays generally refer to a broad category of display technologies which generate their own light, including: electroluminescent displays, field emission displays, plasma displays, vacuum fluorescent displays, carbon-nanotube displays, and polymeric displays such as organic light emitting diode (OLED) displays. In contrast, non-emissive displays require external source of light (such as the backlight of a liquid crystal display). Dynamic autostereoscopic display modules 710 can typically include other optical and structural components described in greater detail below. A number of types of spatial light modulators (SLMs) can be used. In various implementations, non-emissive modulators may be less compact than competing emissive modulators. For example, SLMs may be made using the following technologies: electro-optic (e.g., liquid-crystal) transmissive displays; micro-electro-mechanical (e.g., micromirror devices, including the TI DLP) displays; electro-optic reflective (e.g., liquid crystal on silicon, (LCoS)) displays; magneto-optic displays; acousto-optic displays; and optically addressed devices.

Various data-processing and signal-processing components are used to create the input signals used by display modules 710. In various implementations, these components can be considered as a computational block 701 that obtains data from sources, such as data repositories or live-action inputs for example, and provides signals to display modules 710. One or more multicore processors may be used in series or in parallel, or combinations thereof, in conjunction with other computational hardware to implement operations that are performed by computational block 701. Computational block 701 can include, for example, one or more display drivers 720, a hogel renderer 730, a calibration system 740, and a display control 750.

Each of the emissive display devices employed in dynamic autostereoscopic display modules 710 is driven by one or more display drivers 720. Display driver hardware 720 can include specialized graphics processing hardware such as a graphics processing unit (GPU), frame buffers, high speed memory, and hardware provide requisite signals (e.g., VESA-compliant analog RGB, signals, NTSC signals, PAL signals, and other display signal formats) to the emissive display. Display driver hardware 720 provides suitably rapid display refresh, thereby allowing the overall display to be dynamic. Display driver hardware 720 may execute various types of software, including specialized display drivers, as appropriate.

Hogel renderer 730 generates hogels for display on display module 710 using data for a three-dimensional model 735. In one implementation, 3D image data 735 includes virtual reality peripheral network (VRPN) data, which employs some device independence and network transparency for interfacing with peripheral devices in a display environment. In addition, or instead, 3D image data 735 can use live-capture data, or distributed data capture, such as from a number of detectors carried by a platoon of observers. Depending on the complexity of the source data, the particular display modules, the desired level of dynamic display, and the level of interaction with the display, various different hogel rendering techniques can be used. Hogels can be rendered in real-time (or near-real-time), pre-rendered for later display, or some combination of the two. For example, certain display modules in the overall system or portions of the overall display volume can utilize real-time hogel rendering (providing maximum display updateability), while other display modules or portions of the image volume use pre-rendered hogels.

One technique for rendering hogel images utilizes a computer graphics camera whose horizontal perspective (in the case of horizontal-parallax-only (HPO) and full parallax holographic stereograms) and vertical perspective (in the case for fill parallax holographic stereograms) are positioned at infinity. Consequently, the images rendered are parallel oblique projections of the computer graphics scene, e.g., each image is formed from one set of parallel rays that correspond to one “direction.” If such images are rendered for each of (or more than) the directions that a display is capable of displaying, then the complete set of images includes all of the image data necessary to assemble all of the hogels. This last technique is particularly useful for creating holographic stereograms from images created by a computer graphics rendering system utilizing imaged-based rendering. Image-based rendering systems typically generate different views of an environment from a set of pre-acquired imagery.

Hogels may be constructed and operated to produce a desired light field to simulate the light field that would result from a desired three-dimensional object or scenario. Formally, the light field represents the radiance flowing through all the points in a scene in all possible directions. For a given wavelength, one can represent a static light field as a five-dimensional (5D) scalar function L(x, y, z, θ, φ) that gives radiance as a function of location (x, y, z) in 3D space and the direction (θ, φ) the light is traveling. Note that this definition is equivalent to the definition of plenoptic function. Typical discrete (e.g., those implemented in real computer systems) light-field models represent radiance as a red, green and blue triple, and consider static time-independent light-field data only, thus reducing the dimensionality of the light-field function to five dimensions and three color components. Modeling the light-field thus requires processing and storing a 5D function whose support is the set of all rays in 3D Cartesian space. However, light field models in computer graphics usually restrict the support of the light-field function to four dimensional (4D) oriented line space. Two types of 4D light-field representations have been proposed, those based on planar parameterizations and those based on spherical, or isotropic, parameterizations.

A massively parallel active hogel display can be a challenging display from an interactive computer graphics rendering perspective. Although a lightweight dataset (e.g., geometry ranging from one to several thousand polygons) can be manipulated and multiple hogel views rendered at real-time rates (e.g., 10 frames per second (fps), 20 fps, 25 fps, 30 fps, or above) on a single GPU graphics card, many datasets of interest are more complex. Urban terrain maps are one example. Consequently, various techniques can be used to composite images for hogel display so that the time-varying elements are rapidly rendered (e.g., vehicles or personnel moving in the urban terrain), while static features (e.g., buildings, streets, etc.) are rendered in advance and re-used. It is contemplated that the time-varying elements can be independently rendered, with considerations made for the efficient refreshing of a scene by re-rendering only the necessary elements in the scene as those elements move. The necessary elements may be determined, for example, by monitoring the poses or gestures of a user who interacts with the scene. The aforementioned lightfield rendering techniques can be combined with more conventional polygonal data model rendering techniques such as scanline rendering and rasterization. Still other techniques such as ray casting and ray tracing can be used.

Thus, hogel renderer 730 and 3D image data 735 can include various different types of hardware (e.g., graphics cards, GPUs, graphics workstations, rendering clusters, dedicated ray tracers, etc.), software, and image data as will be understood by those skilled in the art. Moreover, some or all of the hardware and software of hogel renderer 730 can be integrated with display driver 720 as desired.

System 700 also includes elements for calibrating the dynamic autostereoscopic display modules, including calibration system 740 (typically comprising a computer system executing one or more calibration algorithms), correction data 745 (typically derived from the calibration system operation using one or more test patterns) and one or more detectors 747 used to determine actual images, light intensities, etc. produced by display modules 710 during the calibration process. The resulting information can be used by one or more of display driver hardware 720, hogel renderer 730, and display control 750 to adjust the images displayed by display modules 710.

An ideal implementation of display module 710 provides a perfectly regular array of active hogels, each comprising perfectly spaced, ideal lenslets fed with perfectly aligned arrays of hogel data from respective emissive display devices. In reality however, non-uniformities (including distortions) exist in most optical components, and perfect alignment is rarely achievable without great expense. Consequently, system 700 will typically include a manual, semi-automated, or automated calibration process to give the display the ability to correct for various imperfections (e.g., component alignment, optic component quality, variations in emissive display performance, etc.) using software executing in calibration system 740. For example, in an auto-calibration “booting” process, the display system (using external sensor 747) detects misalignments and populates a correction table with correction factors deduced from geometric considerations. Once calibrated, the hogel-data generation algorithm utilizes a correction table in real-time to generate hogel data pre-adapted to imperfections in display modules 710.

Finally, display system 700 typically includes display control software and/or hardware 750. This control can provide users with overall system control including sub-system control as necessary. For example, display control 750 can be used to select, load, and interact with dynamic autostereoscopic images displayed using display modules 710. Control 750 can similarly be used to initiate calibration, change calibration parameters, re-calibrate, etc. Control 750 can also be used to adjust basic display parameters including brightness, color, refresh rate, and the like. As with many of the elements illustrated in FIG. 7, display control 750 can be integrated with other system elements, or operate as a separate sub-system. Numerous variations will be apparent to those skilled in the art.

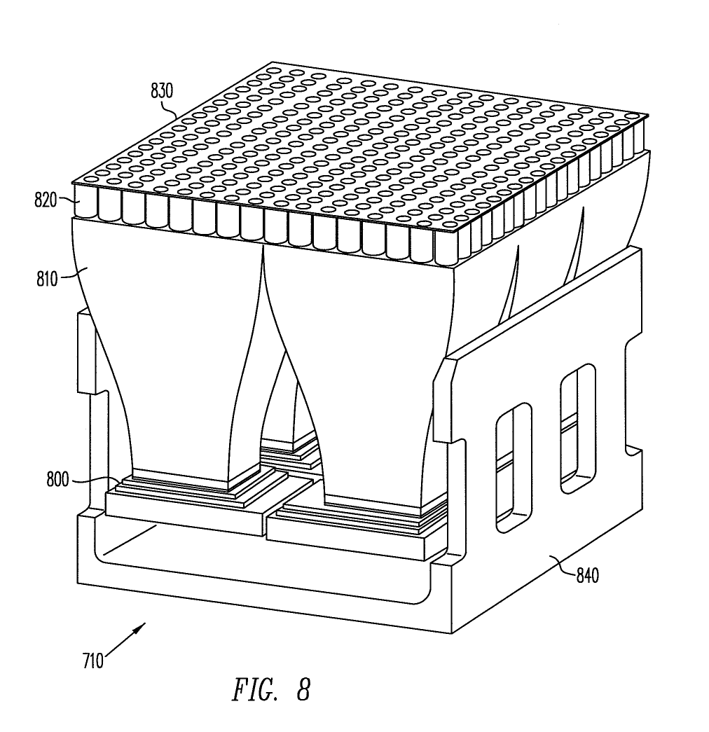

FIG. 8 illustrates an example of a dynamic autostereoscopic display module. Dynamic autostereoscopic display module 710 illustrates the arrangement of optical, electro-optical, and mechanical components in a single module. These basic components include: emissive display 800 which acts as a light source and spatial light modulator, fiber taper 810 (light delivery system), lenslet array 820, aperture mask 830 (e.g., an array of circular apertures designed to block scattered stray light), and support frame 840. Omitted from the figure for simplicity of illustration are various other components including cabling to the emissive displays, display driver hardware, external support structure for securing multiple modules, and various diffusion devices.

Module 710 includes six OLED microdisplays arranged in close proximity to each other. Modules can variously include fewer or more microdisplays. Relative spacing of microdisplays in a particular module (or from one module to the next) largely depends on the size of the microdisplay, including, for example, the printed circuit board and/or device package on which it is fabricated. For example, the drive electronics of displays 800 reside on a small stacked printed-circuit board, which is sufficiently compact to fit in the limited space beneath fiber taper 810. As illustrated, emissive displays 800 cannot be have their display edges located immediately adjacent to each other, e.g., because of device packaging. Consequently, light delivery systems or light pipes such as fiber taper 810 are used to gather images from multiple displays 800 and present them as a single seamless (or relatively seamless) image. In still other embodiments, image delivery systems including one or more lenses, e.g., projector optics, mirrors, etc., can be used to deliver images produced by the emissive displays to other portions of the display module.

The light-emitting surface (“active area”) of emissive displays 800 is covered with a thin fiber faceplate, which efficiently delivers light from the emissive material to the surface with only slight blurring and little scattering. During module assembly, the small end of fiber taper 810 is typically optically index-matched and cemented to the faceplate of the emissive displays 800. In some implementations, separately addressable emissive display devices can be fabricated or combined in adequate proximity to each other to eliminate the need for a fiber taper fiber bundle, or other light pipe structure. In such embodiments, lenslet array 820 can be located in close proximity to or directly attached to the emissive display devices. The fiber taper also provides a mechanical spine, holding together the optical and electro-optical components of the module. In many embodiments, index matching techniques (e.g., the use of index matching fluids, adhesives, etc.) are used to couple emissive displays to suitable light pipes and/or lenslet arrays. Fiber tapers 810 often magnify (e.g., 2:1) the hogel data array emitted by emissive displays 800 and deliver it as a light field to lenslet array 820. Finally, light emitted by the lenslet array passes through black aperture mask 830 to block scattered stray light.

Each module is designed to be assembled into an N-by-M grid to form a display system. To help modularize the sub-components, module frame 840 supports the fiber tapers and provides mounting onto a display base plate (not shown). The module frame features mounting bosses that are machined/lapped flat with respect to each other. These bosses present a stable mounting surface against the display base plate used to locate all modules to form a contiguous emissive display. The precise flat surface helps to minimize stresses produced when a module is bolted to a base plate. Cutouts along the end and side of module frame 840 not only provide for ventilation between modules but also reduce the stiffness of the frame in the planar direction ensuring lower stresses produced by thermal changes. A small gap between module frames also allows fiber taper bundles to determine the precise relative positions of each module. The optical stack and module frame can be cemented together using fixture or jig to keep the module's bottom surface (defined by the mounting bosses) planar to the face of the fiber taper bundles. Once their relative positions are established by the fixture, UV curable epoxy can be used to fix their assembly. Small pockets can also be milled into the subframe along the glue line and serve to anchor the cured epoxy.

Special consideration is given to stiffness of the mechanical support in general and its effect on stresses on the glass components due to thermal changes and thermal gradients. For example, the main plate can be manufactured from a low CTE (coefficient of thermal expansion) material. Also, lateral compliance is built into the module frame itself, reducing coupling stiffness of the modules to the main plate. This structure described above provides a flat and uniform active hogel display surface that is dimensionally stable and insensitive to moderate temperature changes while protecting the sensitive glass components inside.

As noted above, the generation of hogel data typically includes numerical corrections to account for misalignments and non-uniformities in the display. Generation algorithms utilize, for example, a correction table populated with correction factors that were deduced during an initial calibration process. Hogel data for each module is typically generated on digital graphics hardware dedicated to that one module, but can be divided among several instances of graphics hardware (to increase speed). Similarly, hogel data for multiple modules can be calculated on common graphics hardware, given adequate computing power. However calculated, hogel data is divided into some number of streams (in this case six) to span the six emissive devices within each module. This splitting is accomplished by the digital graphics hardware in real time. In the process, each data stream is converted to an analog signal (with video bandwidth), biased and amplified before being fed into the microdisplays. For other types of emissive displays (or other signal formats) the applied signal may be digitally encoded.

Whatever technique is used to display hogel data, generation of hogel data should generally satisfy many rules of information theory, including, for example, the sampling theorem. The sampling theorem describes a process for sampling a signal (e.g., a 3D image) and later reconstructing a likeness of the signal with acceptable fidelity. Applied to active hogel displays, the process is as follows: (1) band-limit the (virtual) wavefront that represents the 3D image, e.g., limit variations in each dimension to some maximum; (2) generate the samples in each dimension with a spacing of greater than 2 samples per period of the maximum variation; and (3) construct the wavefront from the samples using a low-pass filter (or equivalent) that allows only the variations that are less than the limits set in step (1).

An optical wavefront exists in four dimensions: 2 spatial (e.g., x and y) and 2 directional (e.g., a 2D vector representing the direction of a particular point in the wavefront). This can be thought of as a surface—flat or otherwise—in which each infinitesimally small point (indexed by x and y) is described by the amount of light propagating from this point in a wide range of directions. The behavior of the light at a particular point is described by an intensity function of the directional vector, which is often referred to as the k-vector. This sample of the wavefront, containing directional information, is called a hogel, short for holographic element and in keeping with a hogel's ability to describe the behavior of an optical wavefront produced holographically or otherwise. A hogel is also understood as an element or component of a display, with that element or component used to emit, transmit, or reflect a desired sample of a wavefront. Therefore, the wavefront is described as an x-y array of hogels, e.g., SUM[I_{xy}(kₓ,k_{y})], summed over the full range of propagation directions (k) and spatial extent (x and y).

The sampling theorem allows us to determine the minimum number of samples required to faithfully represent a 3D image of a particular depth and resolution. Further information regarding sampling and pixel dimensions may be found, for example, in the '005 application.

In considering various architectures for active hogel displays, the operations of generating hogel data, and converting it into a wavefront and subsequently a 3D image, uses three functional units: (1) a hogel data generator; (2) a light modulation/delivery system; and (3) light-channeling optics (e.g., lenslet array, diffusers, aperture masks, etc.). The purpose of the light modulation/delivery system is to generate a field of light that is modulated by hogel data, and to deliver this light to the light-channeling optics—generally a plane immediately below the lenslets. At this plane, each delivered pixel is a representation of one piece of hogel data. It should be spatially sharp, e.g., the delivered pixels are spaced by approximately 30 microns and as narrow as possible. A simple single active hogel can comprise a light modulator beneath a lenslet. The modulator, fed hogel data, performs as the light modulation/delivery system—either as an emitter of modulated light, or with the help of a light source. The lenslet—perhaps a compound lens—acts as the light-channeling optics. The active hogel display is then an array of such active hogels, arranged in a grid that is typically square or hexagonal, but may be rectangular or perhaps unevenly spaced. Note that the light modulator may be a virtual modulator, e.g., the projection of a real spatial light modulator (SLM) from, for example, a projector up to the underside of the lenslet array.

Purposeful introduction of blur via display module optics is also useful in providing a suitable dynamic autostereoscopic display. Given a hogel spacing, a number of directional samples (e.g., number of views), and a total range of angles (e.g., a 90-degree viewing zone), sampling theory can be used to determine how much blur is desirable. This information combined with other system parameters is useful in determining how much resolving power the lenslets should have. Further information regarding optical considerations such as spotsizes and the geometry of display modules may be found, for example, in the '005 application.

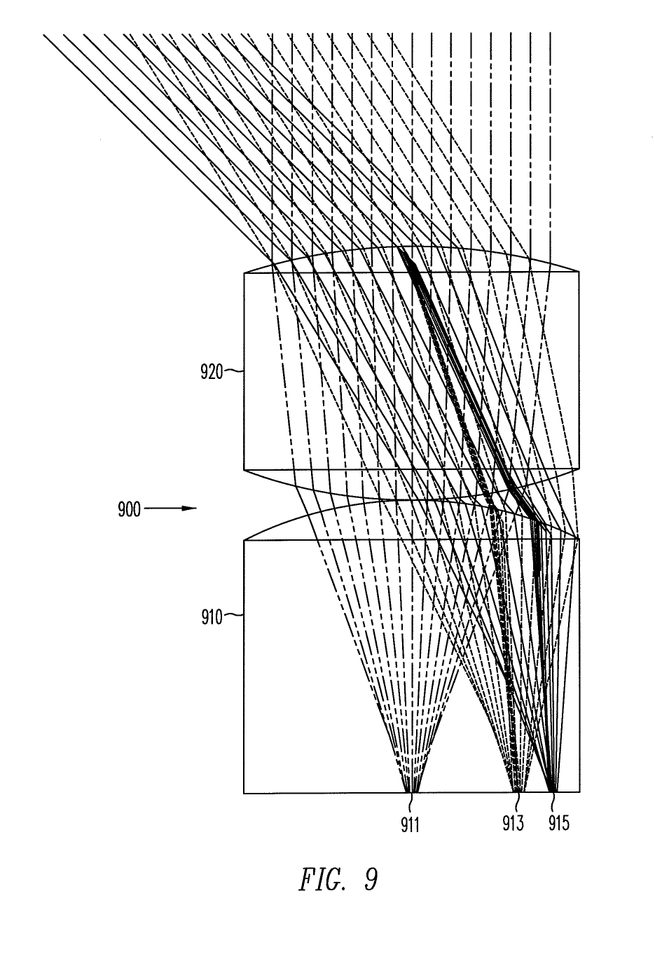

Lenslet array 820 provides a regular array of compound lenses. In one implementation, each of the two-element compound lens is a plano-convex spherical lens immediately below a biconvex spherical lens. FIG. 9 illustrates an example of a multiple element lenslet system 900 that can be used in dynamic autostereoscopic display modules. Light enters plano-convex lens 910 from below. A small point of light at the bottom plane (e.g., 911, 913, or 915, such light emitted by a single fiber in the fiber taper) emerges from bi-convex lens 920 fairly well collimated. Simulations and measurements show divergence of 100 milliradians or less can be achieved over a range of ±45 degrees. The ability to control the divergence of light emitted over a range of 90 degrees demonstrates the usefulness of this approach. Furthermore, note that the light emerges from lens 920 with a fairly high fill factor, e.g., it emerges from a large fraction of the area of the lens. This is made possible by the compound lens. In contrast, with a single element lens the exit aperture is difficult to fill.

Such lens arrays can be fabricated in a number of ways including: using two separate arrays joined together, fabricating a single device using a “honeycomb” or “chicken-wire” support structure for aligning the separate lenses, joining lenses with a suitable optical quality adhesive or plastic, etc. Manufacturing techniques such as extrusion, injection molding, compression molding, grinding, and the like are useful for these purposes. Various different materials can be used such as polycarbonate, styrene, polyamides, polysulfones, optical glasses, and the like.

The lenses forming the lenslet array can be fabricated using vitreous materials such as glass or fused silica. In such embodiments, individual lenses may be separately fabricated, and then subsequently oriented in or on a suitable structure (e.g., a jig, mesh, or other layout structure) before final assembly of the array. In other embodiments, the lenslet array will be fabricated using polymeric materials and using processes including fabrication of a master and subsequent replication using the master to form end-product lenslet arrays.

FIGS. 1-9 illustrate some of the many operational examples of the techniques disclosed in the present application. Those having ordinary skill in the art will readily recognize that certain steps or operations described herein may be eliminated or taken in an alternate order. Moreover, the operations discussed herein may be implemented using one or more software programs for a computer system and encoded in a computer readable medium as instructions executable on one or more processors. The computer readable medium may include an electronic storage medium (e.g., flash memory or dynamic random access memory (DRAM)), a magnetic storage medium (e.g., hard disk, a floppy disk, etc.), or an optical storage medium (e.g., CD-ROM), or combinations thereof.

The software programs may also be carried in a communications medium conveying signals encoding the instructions (e.g., via a network coupled to a network interface). Separate instances of these programs may be executed on separate computer systems. Thus, although certain steps have been described as being performed by certain devices, software programs, processes, or entities, this need not be the case and a variety of alternative implementations will be understood by those having ordinary skill in the art.

Additionally, those having ordinary skill in the art will readily recognize that the techniques described above may be utilized with a variety of different storage devices and computing systems with variations in, for example, the number and type of detectors, display systems, and user input devices. Those having ordinary skill in the art will readily recognize that the data processing and calculations discussed above may be implemented in software using a variety of computer languages, including, for example, traditional computer languages such as assembly language, Pascal, and C; object oriented languages such as C++, C#, and Java; and scripting languages such as Perl and Tcl/Tk. Additionally, the software may be provided to the computer system via a variety of computer readable media and/or communications media.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A system comprising:
a display device for displaying a dynamic three-dimensional image;
a locating system configured to locate and recognize at least one pose made by a user; and
a processor coupled to the locating system and to the display device, and configured to communicate with the display device to revise the dynamic three-dimensional image in response to the pose.

2. The system of claim 1, wherein the processor is configured to modify a shape of at least one three-dimensional object in the three-dimensional image in response to the pose.

3. The system of claim 1, wherein the processor is configured to recognize a pointing pose, to identify an object in the dynamic three-dimensional image in response to the pointing pose, and to modify the dynamic three-dimensional image in response to the pointing pose.

4. The system of claim 1, wherein the processor is configured to recognize a grabbing pose, and to identify an object in the dynamic three-dimensional image as being grabbed.

5. The system of claim 4, wherein the processor is configured to reposition the object in response to a movement of the pose during the grabbing pose.

6. The system of claim 1, wherein the processor is configured to generate an output command signal for the control of physical objects in response to the pose.

7. The system of claim 1, wherein the processor is configured to generate an output command signal suitable for an adjunct processor, wherein:
the adjunct processor is configured to control an adjunct display device to revise an adjunct dynamic three-dimensional image in response to the output command signal.

8. The system of claim 7, wherein:
the adjunct processor is configured to revise the adjunct dynamic three-dimensional image in response to the detection by an adjunct locating system of a pose of a user of the adjunct display device; and
the processor is configured to receive, from the adjunct processor, an input command to revise the dynamic three-dimensional image in response to the pose of the user of the adjunct display device.

9. The system of claim 1, wherein the locating system is configured to locate and recognize poses made by a plurality of users, and the processor is configured to communicate with the display device to revise the dynamic three-dimensional image in response to the poses in a manner that facilitates communication among the users.

10. The system of claim 1, wherein the processor is configured to generate an output in response to a query from the user.

11. The system of claim 10, wherein the output comprises at least one of: an audible response to the query, a visual response to the query, or a haptic response to the query, and the query is at least one of: a spoken query, a pose query, a gestural query, or a keyboard-entered query.

12. The system of claim 11, wherein the processor is configured to generate an output in response to the query and to an accompanying pose indicating at least one object in the dynamic three-dimensional image.

13. The system of claim 1, wherein the processor is configured to generate an output in response to a command from the user.

14. The system of claim 13, wherein the output comprises modifying a shape of at least one three-dimensional object in the three-dimensional image in response to the command, and the command is at least one of: a spoken command, a pose command, a gestural command, or a keyboard-entered command.

15. The system of claim 1, wherein the processor is configured to update the dynamic three-dimensional image to display simultaneously a current situation and a desired situation.

16. The system of claim 1, wherein the pose is a component of a gesture.

17. The system of claim 1, further comprising at least one input device recognizable by the locating system and configured to enable a user to express the pose.

18. The system of claim 17, further comprising:
a first set of one or more tags mounted on the input device and recognizable by the locating system; and
a second set of one or more tags located with a fixed spatial relationship to the image and recognizable by the locating system.

19. The system of claim 17, wherein the input device comprises a glove wearable by a user, and the dynamic three-dimensional image comprises fully-shaded objects.

20. A system comprising:
a display device for displaying a three-dimensional image in a display volume;
a locating system configured to locate and recognize at least one pose made by a user in an interaction volume that overlaps at least partially with the display volume; and
a processor coupled to the locating system and to the display device, and configured to register a pose in the interaction volume as being spatially related to the three-dimensional image in the display volume.

21. The system of claim 20, wherein the processor is configured to modify a shape of at least one three-dimensional object in the three-dimensional image in response to the pose.

22. The system of claim 20, wherein the processor is configured to recognize at least one of a pointing pose or a grabbing pose, to identify an object in the three-dimensional image in response to the identified pose, and to modify the three-dimensional image in response to the identified pose.

23. The system of claim 22, wherein the processor is configured to reposition the identified object in response to a movement of the identified pose.

24. The system of claim 20, wherein the processor is configured to generate an output command signal for the control of physical objects in response to the pose.

25. The system of claim 20, wherein the processor is configured to generate an output command signal suitable for an adjunct processor, wherein:
the adjunct processor is configured to control an adjunct display device to revise an adjunct three-dimensional image in response to the output command signal;
the adjunct processor is configured to revise the adjunct three-dimensional image in response to the detection by an adjunct locating system of a pose of a user of the adjunct display device; and
the processor is configured to receive, from the adjunct processor, an input command to revise the three-dimensional image in response to the pose of the user of the adjunct display device.

26. The system of claim 20, wherein the locating system is configured to locate and recognize poses made by a plurality of users, and the processor is configured to communicate with the display device to revise the three-dimensional image in response to the poses in a manner that facilitates communication among the users.

27. The system of claim 20, wherein the processor is configured to generate a response to a query from the user, and to generate an output in response to a command from the user.

28. A method comprising:
displaying a dynamic three-dimensional image;
locating and recognizing at least one pose made by a user; and
revising the dynamic three-dimensional image in response to the pose.

29. The method of claim 28, wherein the revising comprises modifying a shape of at least one three-dimensional object in the three-dimensional image in response to the pose.

30. The method of claim 28, wherein the pose comprises a pointing pose, the method further comprising:
identifying an object in the dynamic three-dimensional image in response to the pointing pose, and
modifying the dynamic three-dimensional image in response to the pointing pose.

31. The method of claim 28, wherein the pose comprises a grabbing pose, the method further comprising:
identifying an object in the dynamic three-dimensional image as being grabbed.

32. The method of claim 31, further comprising:
repositioning the object in response to a movement of the pose during the grabbing pose.

33. The method of claim 28, wherein the dynamic three-dimensional image comprises fully-shaded dynamic objects, the method further comprising:
generating an output command signal for the control of physical objects in response to the pose.

34. The method of claim 28, further comprising:
generating an output command signal to control an adjunct display device to revise an adjunct dynamic three-dimensional image.

35. The method of claim 28, further comprising:
locating and recognizing poses made by a plurality of users; and
revising the dynamic three-dimensional image in response to the poses in a manner that facilitates communication among the users.

36. The method of claim 28, further comprising:
generating an output in response to a query from a user and to an accompanying pose that indicates at least one object in the dynamic three-dimensional image.

37. The method of claim 28, further comprising:
revising the dynamic three-dimensional image in response to in response to a command from a user and to an accompanying pose that indicates at least one object in the dynamic three-dimensional image.

38. The method of claim 28, further comprising:
updating the dynamic three-dimensional image to display simultaneously a current situation and a desired situation.

39. A method comprising:
displaying a three-dimensional image in a display volume;
locating and recognizing at least one pose made by a user in an interaction volume that overlaps at least partially with the display volume; and
registering a pose in the interaction volume as being spatially related to the three-dimensional image in the display volume.

40. The method of claim 39, further comprising:
modifying a shape of at least one three-dimensional object in the three-dimensional image in response to the pose.

41. The method of claim 39, further comprising:
recognizing at least one of a pointing pose or a grabbing pose;
identifying an object in the three-dimensional image in response to the identified pose; and
modifying the three-dimensional image in response to the identified pose.

42. The method of claim 41, further comprising:
repositioning the identified object in response to a movement of the identified pose.

43. The method of claim 39, further comprising:
generating an output command signal for the control of physical objects in response to the pose.

44. The method of claim 39, further comprising:
generating an output command signal configured to control an adjunct display device to revise an adjunct three-dimensional image in response to the output command signal.

45. The method of claim 39, further comprising:
locating and recognizing poses made by a plurality of users; and
revising the three-dimensional image in response to the poses in a manner that facilitates communication among the users.

46. The method of claim 39, wherein the processor is configured to generate a response to a query from the user, and to generate an output in response to a command from the user.

47. A system comprising:
means for displaying a dynamic three-dimensional image;
means for locating and recognizing at least one pose made by a user; and
means for revising the dynamic three-dimensional image in response to the pose.

48. A system comprising:
means for displaying a three-dimensional image in a display volume;
means for locating and recognizing at least one pose made by a user in an interaction volume that overlaps at least partially with the display volume; and
means for registering a pose in the interaction volume as being spatially related to the three-dimensional image in the display volume.

49. A computer program product comprising:
a computer readable medium; and
instructions encoded on the computer readable medium and executable by one or more processors to perform a method comprising:
displaying a dynamic three-dimensional image;
locating and recognizing at least one pose made by a user; and
revising the dynamic three-dimensional image in response to the pose.

50. A computer program product comprising:
a computer readable medium; and
instructions encoded on the computer readable medium and executable by one or more processors to perform a method comprising:
displaying a three-dimensional image in a display volume;
locating and recognizing at least one pose made by a user in an interaction volume that overlaps at least partially with the display volume; and
registering a pose in the interaction volume as being spatially related to the three-dimensional image in the display volume.
